(19) United States
(12) Patent Application Publication
(10) Pub. No.: US 2008/0018579 A1
(43) Pub. Date: Jan. 24, 2008

(54) LIQUID CRYSTAL DISPLAY AND DRIVING METHOD THEREOF

(76) Inventors: Young-Jun CHOI, Suwon-si (KR); Jun-Hee Moon, Yongin-si (KR); Sang-Jin Pak, Yongin-si (KR)

Correspondence Address: F. CHAU & ASSOCIATES, LLC, 130 WOODBURY ROAD, WOODBURY, NY, 11797, US

(21) Appl. No.: 11/777,513

(22) Filed: Jul. 13, 2007

(30) Foreign Application Priority Data
Jul. 24, 2006 (KR) 10-2006-0069037

(51) Int. Cl. G09G 3/36

(52) U.S. Cl. 345/90

(57) ABSTRACT

A liquid crystal display and a driving method thereof are disclosed. The liquid crystal display includes a plurality of pixels arranged in a matrix, each pixel including a liquid crystal capacitor and a storage capacitor having a first terminal connected to the liquid crystal capacitor and a second terminal applied with a storage electrode voltage. The storage electrode voltage has a first level and a second level that are periodically changed and the first level is higher than the second level, and the storage electrode voltage is dropped by a predetermined compensation value ΔV at the time of change from the first level to the second level and raised by the compensation value ΔV at the time of change from the second level to the first level.

### CROSS-REFERENCE TO RELATED APPLICATION

This application claims priority to Korean Patent Application No. 10-2006-0069037 filed in the Korean Intellectual Property Office on Jul. 24, 2006, the entire contents of which are incorporated herein by reference.

### BACKGROUND OF THE INVENTION

1. Technical Field

The present invention relates to a liquid crystal display, and more particularly, to a liquid crystal display and a driving method thereof.

2. Discussion of the Related Art

A liquid crystal display (LCD) is one of the most widely used flat panel displays. An LCD includes two panels provided with field-generating electrodes such as pixel electrodes and a common electrode, and a liquid crystal (LC) layer interposed therebetween. The LCD displays images by applying voltages to the field-generating electrodes to generate an electric field across the liquid crystal layer, which determines an orientation of liquid crystal molecules in the liquid crystal layer to adjust the polarization of incident light.

The LCD further includes a plurality of switching elements connected to the pixel electrodes and a plurality of signal lines such as gate lines and data lines for controlling the switching elements to apply voltages to the pixel electrodes.

As more LCDs have been used as display devices of computers and display screens of televisions, it has become increasingly important to enable display of moving pictures on the LCD. However, liquid crystal has a relatively slow response speed making it difficult to display fast moving pictures.

Since the liquid crystal molecules have a relatively slow response rate, it takes time for a liquid crystal capacitor in an LCD to be charged to a target voltage level necessary to gain a desired luminance. The time for reaching the target voltage level varies depending on a previous voltage level of the liquid crystal capacitor. In case where the difference between the previous voltage level and the target voltage level is excessively large, the voltage level may not be able to reach the target voltage level during the turn-on of the switching elements.

### SUMMARY OF THE INVENTION

In accordance with one exemplary embodiment of the present invention, a liquid 15 crystal display includes a plurality of pixels arranged in a matrix. Each pixel includes a liquid crystal capacitor and a storage capacitor having a first terminal connected to the liquid crystal capacitor and a second terminal supplied with a storage electrode voltage. The storage electrode voltage has a first level and a second level that are periodically changed. The first level is higher than the second level. The storage electrode voltage is dropped by a predetermined compensation value ΔV at the time of change from the first level to the second level and raised by the compensation value ΔV at the time of change from the second level to the first level.

The compensation value ΔV may be greater than 0V.

The duration At of the compensation value may be longer than 0 seconds and shorter than one horizontal period.

The level of the storage electrode voltage applied to the same storage electrode line may be changed for each frame.

The level of the storage electrode voltage may be changed after the charging of the liquid crystal capacitor.

The level of the storage electrode voltage applied to adjacent storage electrode lines may be different.

The liquid crystal display may be driven by row inversion.

The liquid crystal display may be driven by frame inversion.

The compensation value may vary depending on the gray level of the current frame.

The compensation value may be determined by comparison between an input image signal of the current frame (hereinafter, “current input image signal”) and an input image signal of the previous frame (hereinafter, “previous input image signal”).

The compensation value may be determined by comparison between a mean value of the current input image signal and a mean value of the previous input image signal.

The mean value of the current input image signal and the mean value of the previous input image signal may be calculated in units of pixel rows.

The greater the difference between the mean value of the current input image signal and the mean value of the previous input image signal, the greater the compensation value may be.

The liquid crystal display may further include a plurality of gate lines transmitting gate signals, a plurality of data lines transmitting data voltages, storage electrode lines transmitting a storage electrode voltage, a storage electrode driver generating the storage electrode voltage, and a signal controller correcting an input image signal and outputting the corrected input image signal as an output image signal and controlling the storage electrode driver.

The signal controller may include a first calculator calculating and outputting a mean value of the current input image signal, a buffer unit storing the mean value of the current input image signal and outputting the mean value of the previous input image signal, and a second calculator generating a control signal for determining the compensation value by comparing the mean value of the current input image signal and is the mean value of the previous input image signal.

The control signal may be applied to the storage electrode driver.

The second calculator may include a lookup table.

In accordance with another exemplary embodiment of the present invention, a driving method of a liquid crystal display is provided. The liquid crystal display includes a plurality of pixels, each pixel includes a liquid crystal capacitor and a storage capacitor having a first terminal connected to the liquid crystal capacitor and a second terminal applied with a storage electrode voltage. The driving method includes charging the liquid crystal capacitor, changing the voltage of the liquid crystal capacitor by changing the storage electrode voltage from a first level to a second level, and changing the voltage of the liquid crystal capacitor by changing the storage electrode voltage from the second level to a third level.

The first level may be higher than the second level and the second level may be higher than the third level.

The first level may be lower than the second level and the second level may be lower than the third level.

The difference between the second level and the third level may be the same for each frame.

The difference between the second level and the third level may vary depending on the gray level of the current frame.

The difference between the second level and the third level may be determined by comparing a mean value of an input image signal of the current frame (hereinafter, “current input image signal”) and a mean value of an input image signal of the previous is frame (hereinafter, “previous input image signal”).

The greater the difference between the mean value of the current input image signal and the mean value of the previous input image signal, the greater the difference between the second level and the third level may be.

### BRIEF DESCRIPTION OF THE DRAWINGS

Features of exemplary embodiments of the present disclosure will become apparent and more readily appreciated from the following description taken in conjunction with the accompanying drawings of which:

FIG. 1 is a block diagram of an LCD according to an exemplary embodiment of the present invention;

FIG. 2 is an equivalent circuit diagram of a pixel of an LCD according to an exemplary embodiment of the present invention;

FIG. 3 is a waveform diagram showing a drive signal of an LCD according to an exemplary embodiment of the present invention;

FIG. 4 is a graph showing a pixel electrode voltage and a change of the response speed of liquid crystal depending on the operation of an LCD according to an exemplary embodiment of the present invention;

FIG. 5 is a graph showing a pixel electrode voltage and a change of the response speed of liquid crystal according to the related art;

FIG. 6 a block diagram of an LCD according to another exemplary embodiment of the present invention;

FIG. 7 is a block diagram showing part of a signal controller of an LCD according to another exemplary embodiment of the present invention;

FIG. 8 is a waveform diagram showing a drive signal of an LCD according to another exemplary embodiment of the present invention;

FIG. 9 is a layout view showing an example of a thin film transistor array panel according to an exemplary embodiment of the present invention;

FIG. 10A and FIG. 10B are cross-sectional views taken along lines Xa-Xa and Xb-Xb, respectively, of the thin film transistor array panel of FIG. 9;

FIG. 11 is a layout view showing another example of a thin film transistor array panel according to one exemplary embodiment of the present invention; and

FIG. 12A and FIG. 12B are cross-sectional views taken along lines XIIa-XIIa and XIIb-XIIb, respectively, of the thin film transistor array panel of FIG. 11.

### DETAILED DESCRIPTION OF THE EXEMPLARY EMBODIMENTS

Exemplary embodiments of the present invention will be described more fully hereinafter with reference to the accompanying drawings. As those skilled in the art would realize, the described exemplary embodiments may be modified in various different ways, all without departing from the spirit or scope of the present disclosure.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present.

A liquid crystal display and a driving method thereof according to an exemplary embodiment of the present invention will now be described in detail with reference to the accompanying drawings.

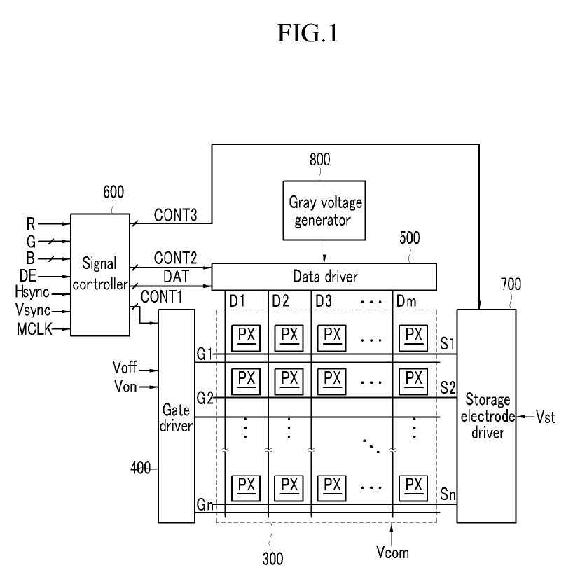

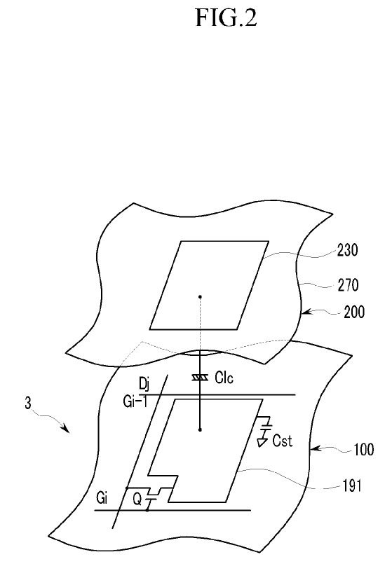

First, a liquid crystal display according to an exemplary embodiment of the present invention will be described with reference to FIG. 1 and FIG. 2.

FIG. 1 is a block diagram of an LCD according to an exemplary embodiment of the present invention and FIG. 2 is an equivalent circuit diagram of a pixel of an LCD according to an exemplary embodiment of the present invention. An LCD according to an exemplary embodiment of the present invention includes a liquid crystal panel assembly 300. A gate driver 400 is provided. A data driver 500 is connected to the liquid crystal panel assembly 300. A storage electrode driver 700 is provided. A gray voltage generator 800 is connected to the data driver 500. A signal controller 600 controls the above-described elements.

In an equivalent circuit view, the liquid crystal panel assembly 300 includes a plurality of signal lines G₁-Gₙ, D₁-Dₘ, and S₁-Sₙ, and a plurality of pixels PX connected thereto and arranged substantially in a matrix. In a structural view as shown in FIG. 2, the liquid crystal panel assembly 300 includes lower and upper panels facing each other, and a liquid crystal layer interposed therebetween.

The signal lines G₁-Gₙ, D₁-Dₘ, and S₁-Sₙ include a plurality of gate lines G₁-Gₙ transmitting gate signals (also referred to as “scanning signals”), a plurality of data lines D₁-Dₘ transmitting data signals, and a plurality of storage electrode lines signal lines S₁-Sₙ transmitting a storage electrode voltage. The gate lines G₁-Gₙ extend substantially in a row direction and substantially parallel to each other, while the data lines D₁-Dₘ extend substantially in a column direction and substantially parallel to each other. The storage electrode lines S₁-Sₙ extend substantially alongside the gate lines G₁-Gₙ and substantially parallel to each other.

Each pixel PX, for example a pixel PX connected to the i-th gate line Gᵢ (i=1, 2, . . . , n) and the j-th data line Dj (j=1, 2, . . . , m), includes a switching element Q connected to the signal lines Gᵢ and Dⱼ, and a liquid crystal capacitor Clc and a storage capacitor Cst that are connected to the switching element Q.

The switching element Q is provided on the lower panel 100 and has three terminals: a control terminal connected to the gate line Gᵢ; an input terminal connected to the data line Dⱼ; and an output terminal connected to both the liquid crystal capacitor Clc and the storage capacitor Cst.

The liquid crystal capacitor Clc includes a pixel electrode 191 provided on the lower panel 100 and a common electrode 270 provided on the upper panel 200 as two terminals. The liquid crystal layer 3 disposed between the two electrodes 191 and 270 functions as a dielectric of the liquid crystal capacitor Clc. The pixel electrode 191 is connected to the switching element Q. The common electrode 270 is supplied with a common voltage Vcom and covers the entire surface of the upper panel 200. The common voltage may be a direct current (DC) voltage having a predetermined magnitude.

As an alternative embodiment to the configuration illustrated in FIG. 2, the common electrode 270 may be provided on the lower panel 100, and at least one of the electrodes 191 and 270 may have a shape of a bar or a stripe.

The storage capacitor Cst is an auxiliary capacitor for the liquid crystal capacitor Clc. When the pixel electrode 191 and the storage electrode lines S₁-Sₙ that are provided on the lower panel 100 are overlapped with each other, and an insulator is interposed therebetween, the overlap portion becomes the storage capacitor Cst. The storage electrode lines S₁-Sₙ are supplied with a storage electrode voltage having a first level and a second level lower than the first level. One example of the first level voltage is 0V, and one example of the second level voltage is 5V.

For a color display, each pixel uniquely exhibits one of three primary colors (i.e., spatial division), or sequentially exhibits three primary colors in turn depending on time (i.e., temporal division), so that a spatial or temporal sum of the primary colors is recognized as a desired color. An example of a set of the primary colors includes the additive primary colors red, green, and blue. FIG. 2 shows an example of the spatial division in which each pixel includes a color filter 230 for exhibiting one of the primary colors in an area of the upper panel 200 corresponding to the pixel electrode 191. Unlike in FIG. 2, the color filter 230 may be provided on or under the pixel electrode 191 of the lower panel 100.

### At least one polarizer (not shown) is provided on outer surfaces of the liquid crystal panel assembly 300 for polarizing the light.

Referring to FIG. 1 again, the gray voltage generator 800 generates two sets of gray voltages related to a transmittance of the pixels. The gray voltages in a first set have a positive polarity with respect to the common voltage Vcom, while of the gray voltages in a second set have a negative polarity with respect to the common voltage Vcom.

The gate driver 400 is connected to the gate lines G₁-Gₙ of the liquid crystal panel assembly 300 for applying the gate signals including combinations of gate-on voltages Von and gate-off voltages Voff to the gate lines G₁-Gₙ.

The data driver 500 is connected to the data lines D₁-Dₘ of the liquid crystal panel assembly 300, and selects gray voltages from the gray voltage generator 800 as data signals and applies them to the data lines D₁-Dₘ. However, in a case where the gray voltage generator 800 does not provide all voltages for all gray scales but only provides a predetermined number of reference gray voltages, the data driver 500 divides the reference gray voltages to generate gray voltages for the entire gray scale and selects data signals among them.

The storage electrode driver 700 is connected to the storage electrode lines S₁-Sₙ of the liquid crystal panel assembly 300, and applies a storage electrode voltage consisting of voltages of first and second levels to the storage electrode lines S₁-Sₙ. The operation of the storage electrode driver 700 will be described below in more detail.

The signal controller 600 controls the gate driver 400 and the data driver 500. Each of the drivers 400, 500, 600, 700, and 800 may be directly mounted as at least one integrated circuit chip mounted on the liquid crystal panel assembly 300. The drivers may alternatively be mounted on a flexible printed circuit film (not shown) in a tape carrier package (TCP) type which are attached to the liquid crystal panel assembly 300. The drivers may alternatively be mounted on a separate printed circuit board (not shown). Alternatively, the drivers 400, 500, 600, 700, and 800 may be directly integrated with the LC panel assembly 300 along with the signal lines G₁-Gₙ, D₁-Dₘ, S₁-Sₙ, and the thin film transistor switching element Q, etc. Further, the drivers 400, 500, 600, 700, and 800 may be integrated as a single chip. In this case, at least one of the drivers 400, 500, 600, 15 700, and 800 or at least one circuit device comprising the drivers may be located at the outside of the single chip.

Hereinafter, operation of the LCD will be described in detail.

The signal controller 600 receives input image signals R, G, and B from an external graphics controller (not shown) and input control signals for controlling a display thereof. Examples of the input control signal include a vertical synchronization signal Vsync, a horizontal synchronizing signal Hsync, a main clock signal MCLK, a data enable signal DE, etc.

In response to the input image signals R, G, and B and the input control signals, the signal controller 600 processes the input image signals R, G, and B for operating the LC panel assembly 300 and generates gate control signals CONT1, data control signals CONT2, and storage electrode control signals CONT3. The gate control signals CONT1 is output to the gate driver 400. The data control signals CONT2 and processed image signals DAT are output to the data driver 500. The storage electrode control signals CONT3 is output to the storage electrode driver 700.

The gate control signals CONT1 include a scanning start signal STV for instructing the start of scanning, and at least one clock signal for controlling an output time of the gate-on voltage Von. The gate control signals CONT1 may further include an output enable signal OE for defining a duration of the gate-on voltage Von.

The data control signals CONT2 include a horizontal synchronizing start signal STH for identifying a beginning of a data transmission of image signals for a row of pixels PX, and a load signal LOAD for instructing to apply the data signals to the data lines D₁-Dₘ. The data control signals CONT2 may further include a reverse signal RVS for reversing a polarity of the voltage of the data signals with respect to the common voltage Vcom (hereinafter, “a polarity of the voltage of the data signals” will be abbreviated as “a polarity of the data signals”).

The storage electrode control signals CONT3 may include a signal for controlling a timing for changing the level of a storage electrode voltage, a signal for controlling a compensation value of a storage electrode voltage, and so on.

In response to the data control signals CONT2 from the signal controller 600, the data driver 500 receives digital image signals DAT for a row of pixels PX from the signal controller 600, converts the digital image signals DAT into analog data signals by selecting gray voltages corresponding to the digital image signals DAT, and then applies the analog data signals to corresponding data lines D₁-Dₘ.

The gate driver 400 applies the gate-on voltage Von to the gate lines (G₁-Gₙ) in response to the gate control signals CONT1 from the signal controller 600, thereby turning on switching elements Q connected to the gate lines G₁-Gₙ. The data voltages applied to the data lines D₁-Dₘ are applied to corresponding pixels PX by turning-on switching elements Q.

The storage electrode driver 700 sequentially applies a storage electrode voltage Vst to the storage electrode lines S₁-Sₙ. The storage electrode voltage Vst is based on a driving voltage Vst provided from outside the storage electrode driver. The storage electrode voltage Vst is provided by the storage electrode driver 700 to change a voltage applied to the pixel electrode 191, for example, a pixel electrode voltage Vp. The storage electrode voltage Vst is applied after the completion of a charging operation of a pixel, for example, when a gate signal applied to the corresponding gate line G₁-Gₙ changes from the gate-on voltage Von to the gate-off voltage Voff. The level of a storage electrode voltage applied to an adjacent storage electrode line is reversed. For example, if the storage electrode voltage applied to a certain storage electrode line has a voltage of a high level, the storage electrode voltage applied to a next adjacent storage electrode line has a voltage of a low level. The operation of the storage electrode driver 700 will be described below in more detail.

As previously explained, the difference between the pixel electrode voltage applied to the pixel PX and the common voltage Vcom is represented as a voltage across the liquid crystal capacitor Clc, namely, a pixel voltage. The liquid crystal molecules in the liquid crystal capacitor Clc have orientations that depend on a magnitude of the pixel voltage. Polarization of light passing through the liquid crystal layer 3 is varied according to orientations of the liquid crystal molecules. The polarizer attached to the liquid crystal panel assembly 300 converts a difference of light polarization into a difference of light transmittance.

By repeating the above-mentioned procedure each horizontal period (which is denoted by “1H” and is equal to one period of the horizontal synchronizing signal Hsync and the data enable signal DE), all gate lines G₁-Gₙ are sequentially supplied with the gate-on voltage Von, thereby applying the data signals to all pixels PX to display images of one frame.

When a next frame starts after finishing one frame, the reverse signal RVS applied to the data driver 500 is controlled such that the polarity of the data voltages applied to each pixel PX is reversed with respect to that of a previous frame (which is referred to as “frame inversion”). The reverse signal RVS may also be controlled such that the polarity of the data signals flowing in a data line in one frame are reversed, and the polarity of the data signals in one pixel row are the same (row inversion).

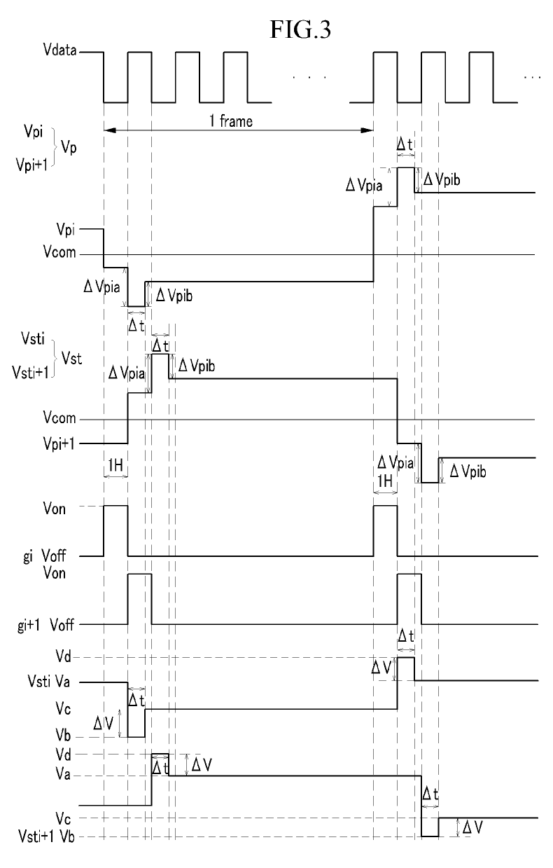

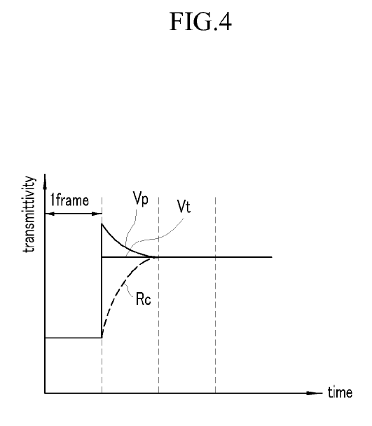

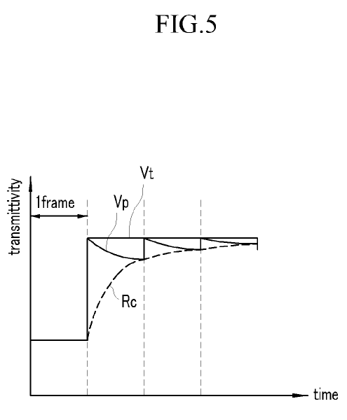

The operation of a liquid crystal display according to one exemplary embodiment of the present invention will be described in more detail with reference to FIG. 3.

### FIG. 3 is a waveform diagram showing a drive signal of an LCD according to an exemplary embodiment of the present invention.

Referring to FIG. 3, for the i-th pixel row, when a gate-on voltage Von is applied to a gate signal gᵢ applied to the i-th gate line Gᵢ from the gate driver 400, the liquid crystal capacitor Clc of the pixel row connected to the i-th gate line Gᵢ is charged. The storage electrode voltage Vsti applied to the i-th storage electrode line Sᵢ keeps a first level Va.

After a lapse of about 1H, the gate signal gᵢ applied to the i-th gate line Gᵢ is changed to a gate-off voltage Voff, and the storage electrode voltage Vsti applied to the i-th storage electrode line Sᵢ is changed to a second level Vb. The second level Vb is lower than the first level Va.

After a lapse of a predetermined time Δt (hereinafter, “correction time”), the storage electrode voltage Vsti applied to the i-th storage electrode line Sᵢ is changed to a third level Vc. The correction time Δt is less than 1H, and the third level Vc is higher than the second level Vb and lower than the first level Va. Here, the difference between the second level Vb and the third level Vc is referred to as a compensation value ΔV.

While a data voltage Vd is applied to the i-th pixel row by the application of the gate-on voltage Von, the i-th pixel electrode voltage Vpi is affected only by the data voltage Vd. However, after the gate-on voltage Von is applied, the storage electrode voltage Vsti applied to the i-th storage electrode line Sᵢ is changed from the first level Va to the second level Vb that is lower than the first level Va so that the capacitance of the storage capacitor Cst is changed.

The data voltage Vd applied to the j-th data line Dj from the data driver 500 is driven by row inversion, which is performed in units of rows, and the i-th pixel electrode voltage Vpi changes from the positive polarity (+) to the negative polarity (−). Afterwards, the i-th pixel electrode voltage Vpi changes according to a change in the capacitance of the storage capacitor Cst, and is dropped by a first variation amount ΔVpia. After a lapse of a correction time Δt, the pixel electrode voltage Vpi rises by a second variation amount ΔVpib. The pixel electrode voltage Vpi remains in that state until the start of the next frame.

When the next frame starts, a gate-on voltage Von is applied to a gate signal gᵢ applied to the i-th gate line Gᵢ from the gate driver 400, and the liquid crystal capacitor Clc of the pixel row connected to the i-th gate line Gᵢ is charged. The storage electrode voltage Vsti applied to the i-th storage electrode line Sᵢ maintains the third level Vc.

After a lapse of about 1H, the gate signal gᵢ applied to the i-th gate line Gᵢ is changed to a gate-off voltage Voff, and the storage electrode voltage Vsti applied to the i-th storage electrode line Sᵢ is changed to a fourth level Vd. The fourth level Vd is lower than the third level Vc.

After a lapse of a correction time Δt, the storage electrode voltage Vsti applied to the i-th storage electrode line Sᵢ is changed again to the first level Va. The correction time Δt is less than 1H, and the first level Va is higher than the third level Vc and lower than the fourth level Vd. The difference between the fourth level Vd and the first level Va is equal to a compensation value ΔV, which is the difference between the second level Vb and the third level Vc.

In response to the data voltage Vd driven by row inversion, the i-th pixel electrode voltage Vpi changes from the negative polarity (−) to the positive polarity (+) in the next frame. Afterwards, the i-th pixel electrode voltage Vpi changes according to a change in the capacitance of the storage capacitor Cst, and rises by a first variation amount ΔVpia. After a lapse of a correction time Δt, the pixel electrode voltage Vpi is dropped again by a second variation amount ΔVpib. The pixel electrode voltage Vpi remains in that state until the start of the next frame.

The i+1-th pixel row will now be described. When a gate-on voltage Von is applied to a gate signal gᵢ₊₁ applied to the (i+1)-th gate line Gᵢ₊₁ from the gate driver 400, the liquid crystal capacitor Clc of the pixel row connected to the (i+1)-th gate line Gᵢ₊₁ is charged. The phase of the storage electrode voltage Vsti+1 applied to the (i+1)-th storage electrode line Sᵢ₊₁ is opposite to that of the i-th storage electrode line Sᵢ. Accordingly, at first, the storage electrode voltage Vsti+1 applied to the (i+1)-th storage electrode line Sᵢ₊₁ maintains the third level Vc.

After a lapse of about 1H, the gate signal gᵢ₊₁ applied to the (i+1)-th gate line Gᵢ₊₁ is changed to a gate-off voltage Voff, and the storage electrode voltage Vsti+1 applied to the (i+1)-th storage electrode line Sᵢ₊₁ is changed to the fourth level Vd. As explained above, the fourth level Vd is higher than the third level Vd.

After a lapse of a correction time Δt, the storage electrode voltage Vsti+1 applied to the (i+1)-th storage electrode line Sᵢ₊₁ is changed to the first level Va.

Since the data driver 500 is driven by row inversion, the (i+1)-th pixel electrode voltage Vpi+1 has a polarity opposite to that of the i-th pixel electrode voltage Vpi, and changes from the negative polarity (−) to the positive polarity (+). Afterwards, the (i+1)-th pixel electrode voltage Vpi+1 changes according to a change in the capacitance of the storage capacitor Cst, and rises by a first variation amount ΔVpia. After a lapse of a correction time Δt, the pixel electrode voltage Vpi is dropped again by a second variation amount ΔVpib. The pixel electrode voltage Vpi remains in that state until the start of the next frame.

When the next frame starts, a gate-on voltage Von is applied to a gate signal gᵢ₊₁ applied to the (i+1)-th gate line Gᵢ₊₁ from the gate driver 400, and the liquid crystal capacitor Clc of the pixel row connected to the (i+1)-th gate line Gᵢ₊₁ is charged. The storage electrode voltage Vsti+1 applied to the (i+1)-th storage electrode line Sᵢ₊₁ maintains the first level Va.

### After a lapse of about 1H, the gate signal gᵢ₊₁ applied to the (i+1)-th gate line Gᵢ₊₁ is changed to a gate-off voltage Voff, and the storage electrode voltage Vsti+1 applied to the (i+1)-th storage electrode line Sᵢ₊₁ is changed to the second level Vb.

After a lapse of a correction time Δt, the storage electrode voltage Vsti+1 applied to the (i+1)-th storage electrode line Sᵢ₊₁ is changed again to the third level Vc.

In response to the data voltage Vd driven by row inversion, the i-th pixel electrode voltage Vpi changes from the positive polarity (+) to the negative polarity (−). Afterwards, the (i+1)-th pixel electrode voltage Vpi+1 changes according to a change in the capacitance of the storage capacitor Cst, and is dropped by a first variation amount ΔVpia. After a lapse of a correction time Δt, the pixel electrode voltage Vpi rises again by a second variation amount ΔVpib. The pixel electrode voltage Vpi remains in that state until the start of the next frame.

Now, a change in pixel electrode voltage Vpi according to a change in storage electrode voltage Vsti will be described in detail.

First, pixel electrode voltage Vp is obtained as in Equation 1 below. In Equation 1, Clc and Cst represent the capacitance of a liquid crystal capacitor and the capacitance of a storage capacitor, respectively. V_{H} represents a storage electrode voltage Vst of a high level, and V_{L} represents a storage electrode voltage Vst of a low level. For example, among the two levels before and after a change of the first to fourth levels Va, Vb, Vc, and Vd, a relatively higher level is denoted by V_{H}, and a relatively lower level is denoted by V_{L}. As seen from Equation 1, the pixel electrode voltage Vp is the sum of variation amounts A to be added to or deducted from the change in data voltage Vd, capacitance of the capacitors Clc and Cst, and storage electrode voltage Vst.

$${V}_{p} = {V}_{d} q Δ = {V}_{d} q \frac{{C}_{st}}{{C}_{st} + {C}_{lc}} ( {V}_{H} - {V}_{L} ) \qquad ( Equation 1 )$$

The pixels are designed such that the data voltage Vd has a range of about 0V to 5V, and the values of Cst and Clc are equal to each other. If V_{H}-V_{L}=5V, Equation 1 becomes Vp=Vd±2.5.

As a result, when the storage electrode voltage Vst changes, the pixel electrode voltage Vp increases or decreases by ±2.5V from the data voltage Vd applied via the corresponding data lines D₁-Dₘ according to the polarity of the data voltage Vd. For example, if the polarity is positive (+), the pixel electrode voltage Vp increase by 2.5V, and if the polarity is negative (−), the pixel electrode voltage Vp decreases by 2.5V. Due to such a change in pixel electrode voltage Vp, the range of the pixel voltage also increases. For example, when the common voltage Vcom is about 2.5V, the pixel voltage caused by the data voltage Vd of about 0 to 5V applied to the pixels has a range of about −2.5V to +2.5V. When the storage electrode voltage Vs changes to a high level voltage V_{H} and a low level voltage V_{L}, the pixel voltage has a wider range of about −5V to +5V.

In this way, the range of the pixel voltage becomes wider by a variation amount ΔV in pixel electrode voltage Vp that is increased by a change V_{H}-V_{L} in storage electrode voltage. Thus, the voltage range for gray scale representation increases, to thereby improve luminance.
Further, the common voltage is fixed at a predetermined voltage, so power consumption is reduced in comparison with the alternate application of a low voltage and a high voltage. For example, in a parasitic capacitor generated between the data lines and the common electrode, if the common voltage applied to the common electrode is about 0 or 5V, the voltage applied to the parasitic capacitor is about ±5V at maximum. However, if the common voltage is fixed at about 2.5V, the voltage applied to the parasitic capacitor generated between the data lines and the common electrode is reduced to about ±2.5V at maximum. Accordingly, the power consumed in the parasitic capacitor generated between the data lines and the common electrode is reduced, to thereby reduce the overall power consumption of the liquid crystal display.

However, due to a relatively slow response speed of liquid crystal, liquid crystal molecules do not quickly react according to the pixel voltage. Therefore, the capacitance of the liquid crystal capacitor Clc is varied according to whether the liquid crystal molecules reach a stabilized state, at which the realignment of the liquid crystal molecules is completed in reaction to the pixel voltage applied to both ends of the liquid crystal capacitor Clc. Due to this, the pixel electrode voltage Vp is varied according to whether the liquid crystal molecules reach a stabilized state.

Next, a change in pixel electrode voltage Vp is described below with respect to the case of whether the liquid crystal molecules reach the stabilized state in reaction to the pixel voltage.

It is assumed that the capacitance of the liquid crystal capacitor Clc obtained when the liquid crystal molecules reach the stabilized state after applying the pixel voltage of the maximum value, e.g., the pixel voltage of the maximum gray level (white gray level in a normally black mode) to the liquid crystal capacitor Clc, is about three times the capacitance of the liquid crystal capacitor Clc obtained when the liquid crystal molecules reach the stabilized state after applying the pixel voltage of the minimum value, e.g., the pixel voltage of the minimum gray level (black gray level in a normally black mode) to the liquid crystal capacitor Clc. Also, it is assumed that V_{H}-V_{L}=5V and Clc=Cst.

Accordingly, the pixel electrode voltage Vp obtained when the liquid crystal molecules reach the stabilized state after applying the pixel voltage of the maximum gray level to the liquid crystal capacitor Clc is as seen in Equation 1, and as previously stated, because V_{H}-V_{L}=5V and Clc=Cst, the pixel electrode voltage Vp becomes Vp=Vd±2.5. However, if the liquid crystal molecules do not reach the stabilized state after applying the pixel electrode voltage of the maximum gray level to the liquid crystal capacitor Clc, the pixel electrode voltage Vp is as seen in Equation 2:

$$\begin{matrix}{V}_{p} = {V}_{d} q Δ \\ = {V}_{q} q \frac{{C}_{st}}{{C}_{st} + {C}_{lc}} ( {V}_{H} - {V}_{L} ) \text{)} \\ = {V}_{d} q \frac{{C}_{st}}{{C}_{st} + \frac{1}{3} {C}_{st}} s ( {V}_{H} - {V}_{L} ) \\ = {V}_{d} q \frac{3}{4} s ( {V}_{H} - {V}_{L} )\end{matrix} \qquad ( Equation 2 )$$

wherein because V_{H}-V_{L} =5V, the variation amount Δ is 3.75V.

In this way, if the liquid crystal molecules do not reach the stabilized state after applying the pixel electrode voltage of the maximum gray level to the liquid crystal capacitor Clc, the pixel electrode voltage Vp maintains the pixel electrode voltage obtained when the liquid crystal molecules reach the stabilized state after applying the pixel voltage of the minimum gray level to the liquid crystal capacitor Clc. For example, the state of the previous frame is maintained. Accordingly, a variation amount ΔV in pixel electrode voltage Vp caused by a change V_{H}-V_{L} in storage electrode voltage increases from ±2.5V to ±3.75V.

Accordingly, in the case of a change from the pixel electrode voltage of the minimum gray level to the pixel electrode voltage of other gray levels, a variation amount ΔV in pixel electrode voltage Vp caused by a change V_{H}-V_{L} in storage electrode voltage is further increased according to Equation 2 before the liquid crystal molecules reach the stabilized state, and if V_{H}-V_{L}=5V, the variation amount ΔV in pixel electrode voltage Vp is increased up to +3.75V at maximum.

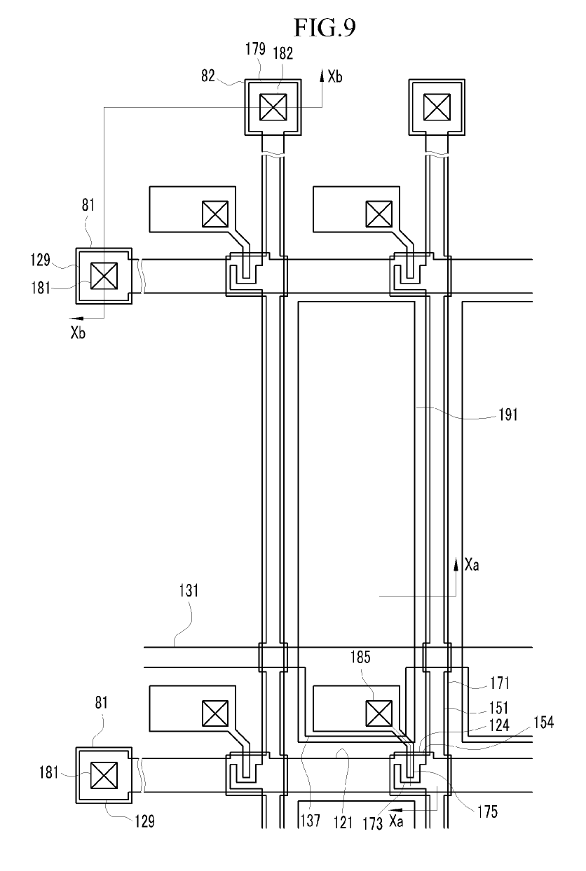

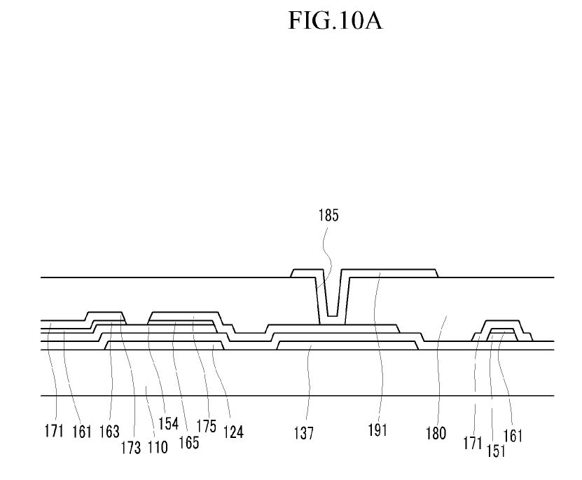

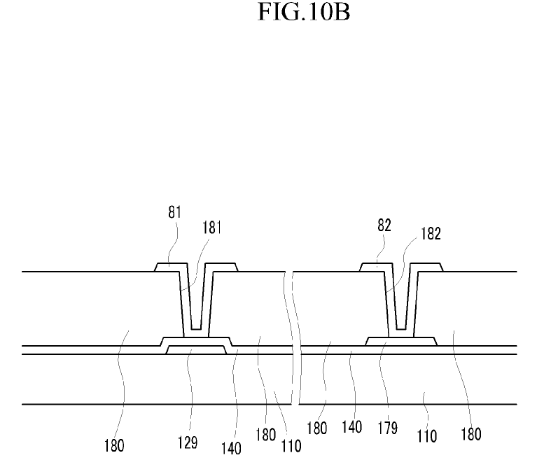

Due to this, in the prior art, as shown in FIG. 10, even if the pixel electrode voltage Vp corresponding to a target pixel electrode voltage V_{T} is applied to the corresponding pixel electrode for each frame, the pixel electrode voltage Vp charged in the pixel electrode is reduced by the effect of an adjacent data voltage after completion of a charging operation, and as a result, does not reach the target pixel electrode voltage V_{T} within one frame but reaches the target pixel electrode voltage V_{T} throughout a number of frames. On the contrary, in this exemplary embodiment, as shown in FIG. 9, a far higher voltage than the target pixel electrode voltage V_{T} is applied as the pixel electrode voltage Vp to the corresponding pixel electrode, and thus the corresponding pixel electrode within one frame reaches the target pixel electrode voltage V_{T}, thereby quickening the response speed of the liquid crystal as compared to other approaches.

If the variation amount V_{H}-V_{L} in storage electrode voltage is not sufficient, the variation amount in pixel electrode voltage is also not sufficient, which makes it difficult to expect an improvement in response speed of the liquid crystal. However, when the variation amount in storage electrode voltage is increased, the power consumption rises. As explained above, in the liquid crystal display according to this exemplary embodiment, the storage electrode voltage Vst has the second level Vb lower than the third level Vc before it is changed from the first level Va to the third level Vc, and has the fourth level Vd higher than the first level Va before it is changed from the third level Vc to the first level Va. The second level Vb and the fourth level Vd instantly increase the variation amount of the storage electrode voltage, and accordingly increase the variation amount ΔV of the pixel electrode voltage, resultantly improving the response speed of the liquid crystal. The duration of the second level Vb and the fourth level Vd is shorter than the duration of the first and third levels Va and Vc, and further is shorter than the application time of the gate-on voltage Von, thus quickening the response speed of the liquid crystal without causing excessive power consumption.

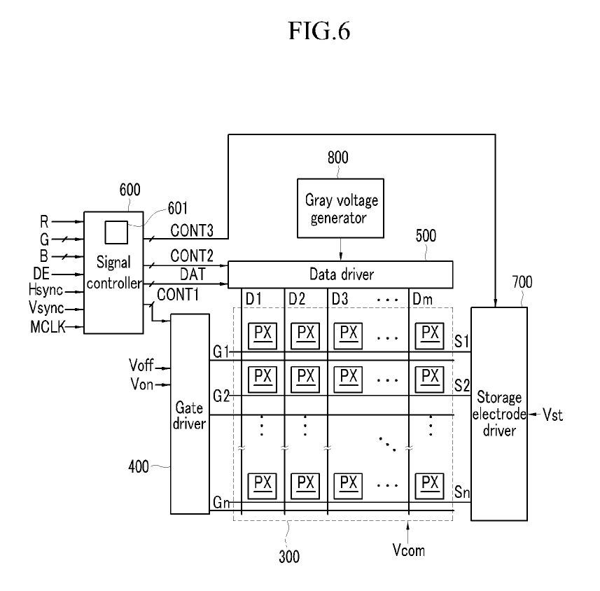

A liquid crystal display according to another exemplary embodiment of the present invention will now be described in detail with reference to FIGS. 6 to 8. FIG. 6 a block diagram of an LCD according to this exemplary embodiment of the present invention.

Referring to FIG. 6, an LCD according to an exemplary embodiment includes a liquid crystal panel assembly 300, a gate driver 400 and a data driver 500 connected to the liquid crystal panel assembly 300, a storage electrode driver 700, a gray voltage generator 800 connected to the data driver 500, and a signal controller 600 controlling the above-described elements.

In the liquid crystal display of FIG. 6, the signal controller 600 includes a control signal corrector 601 for receiving an image signal from the outside and correcting and outputting the same.

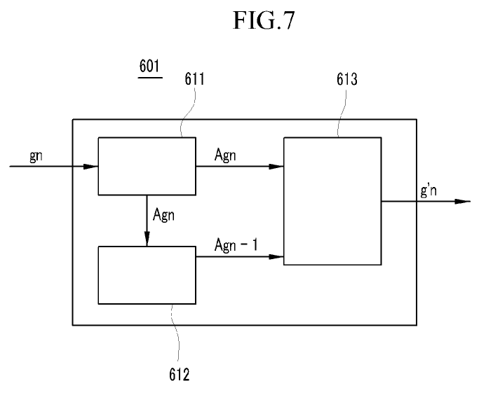

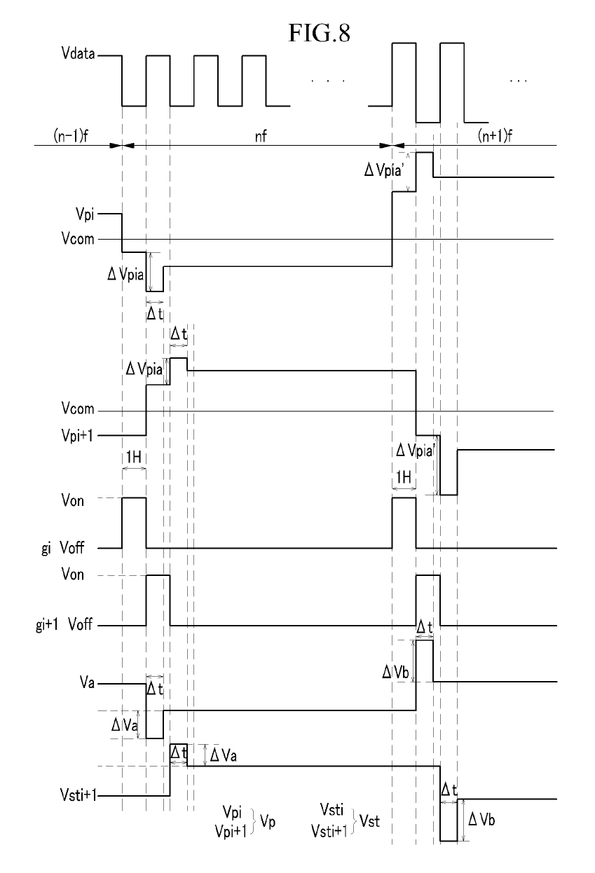

The control signal corrector 601 is described below in detail with reference to FIGS. 7 and 8.

FIG. 7 is a block diagram showing part of a signal controller of an LCD according to an exemplary embodiment of the present invention, and FIG. 8 is a waveform diagram showing a drive signal of an LCD according to this exemplary embodiment of the present invention.

### Referring to FIG. 7, the control signal corrector 601 according to this exemplary embodiment includes a first calculator 611, a buffer unit 612, and a second calculator 613 connected to the first calculator 611 and the buffer unit 612.

The first calculator 611 averages the values of an image signal (hereinafter, “current input image signal”) inputted from the outside to the current frame to calculate a mean value Agn of the current input image signal, and outputs the same to the buffer unit 612 and the second calculator 613.

The buffer unit 612 receives and stores the mean value Agn of the current input image signal from the first calculator 611, and then outputs the same as a mean value Agn-1 of an image signal (hereinafter, “previous input image signal”) inputted into the previous frame.

The second calculator 613 is supplied with a mean value Agn of the current input image signal from the first calculator 611 and with a mean value Agn-1 of the previous input image signal from the buffer unit 612, compares them, and produces an output value g′n for determining a storage electrode voltage Vst. The output value g′n of the second calculator 613 is inputted into the storage electrode driver 700 as part of the storage electrode control signal CONT3, thereby substantially increasing and decreasing the level of the storage electrode voltage Vst.

When a difference between the current input image signal and the previous input image signal is large, a difference between an actual pixel voltage and a target pixel voltage becomes larger, thereby further decreasing the response speed of the liquid crystal. Accordingly, if the capacitance of the storage capacitor Cst is increased by increasing a compensation value ΔV of the storage electrode voltage Vst, a variation amount of the liquid crystal capacitor Clc is also increased, resultantly obtaining a target transmittivity within a shorter time. If the variation amount ΔV of the storage electrode voltage Vst is set to be uniform with respect to the case where the difference between the actual pixel voltage and the target pixel voltage is large, the power consumption becomes larger when no large variation amount ΔV is needed. Accordingly, the response speed of the liquid crystal can be ensured while reducing the power consumption by varying the variation amount ΔV of the storage electrode voltage Vst according to circumstances.

An output value g′n of the second calculator 613 can be determined experimentally, and the second calculator 613 may consist of a lookup table for storing the relationship of the output value g′n of the second calculator 613 with respect to the mean value Agn of the current input image signal and the mean value Agn-1 of the previous input image signal.

Referring to FIG. 8, data voltages corresponding to a target pixel voltage in an (n-1)-th frame and an n-th frame are substantially the same, while data voltages corresponding to the target pixel voltage in an n-th frame and (n+1)-th frame are different from each other. Δt this point, the variation amount ΔVa in the storage electrode voltage Vst between the (n-1)-th frame and the n-th frame is larger than the variation amount ΔVb in the storage electrode voltage Vst between the n-th frame and the (n+1)-th frame. Then, the variation amount ΔVpia in the pixel electrode voltage Vp in the first frame is larger than the variation amount ΔVpia′ in the pixel electrode voltage Vp in the second frame. Accordingly, even when the difference between the current input image signal and the previous input image signal is large, a target luminance can be reached more quickly by increasing the response speed.

Next, a detailed structure of a thin film transistor array panel of a liquid crystal display according to an exemplary embodiment of the present invention will be described in detail with reference to the accompanying drawings.

An example of the thin film transistor array panel of the liquid crystal panel according to an exemplary embodiment of the present invention will be described with reference to FIG. 9 to FIG. 10B.

FIG. 9 is a layout view showing an example of a thin film transistor array panel according to an exemplary embodiment of the present invention, and FIG. 10A and FIG. 10B are cross-sectional views taken along lines Xa-Xa and Xb-Xb, respectively, of the thin film transistor array panel of FIG. 9.

A plurality of gate lines 121 and a plurality of storage electrode lines 131 are formed on an insulating substrate 110 made of transparent glass or plastic.

The gate lines 121 transmit gate signals and extend substantially in a transverse direction. Each gate line 121 includes a plurality of gate electrodes 124 projecting upward and an end portion 129 having a large area for contact with another layer or an external driving circuit.

A gate driving circuit (not shown) for generating the gate signals may be mounted on a flexible printed circuit film (not shown), which may be attached to the insulating substrate 110, directly mounted on the substrate 110, or integrated with the insulating substrate 110. The gate lines 121 may extend to be directly connected to a gate driving circuit that may be integrated with the insulating substrate 110.

Each storage electrode line 131 extends substantially in a transverse direction, and includes a plurality of enlarged portions 137 whose width extends downward. Each storage electrode line 131 may include an end portion having a large area for contact with another layer or an external driving circuit. The shapes and arrangement of the storage electrode lines 131 may be modified in various manners.

Voltages of a first level Va and a third level Vc lower than the first level Va are alternately applied to each storage electrode line 131 in units of frames. When the voltage is changed from the first level Va to the third level Vc, a second level Vb lower than the third level Vc is applied for a predetermined time Δt, and when the voltage is changed from the third level Vc to the first level Va, a fourth level Vd higher than the first level Va is applied for a predetermined time Δt. As explained above, the second and fourth levels Vb and Vd may be lower or higher according to the previous input image signal and the current input image signal.

A storage electrode line driving circuit (not shown) for generating storage voltages may be mounted on a flexible printed circuit film (not shown), which may be attached to the insulating substrate 110, directly mounted on the substrate 110, or integrated with the insulating substrate 110. The storage electrode lines 131 may extend to be directly connected to a storage electrode line driving circuit that may be integrated with the insulating substrate 110.

The gate lines 121 and the storage electrode lines 131 may be made of an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), titanium (Ti), or tantalum (Ta). However, they may have a multi-layered structure including two conductive layers (not shown) having different physical properties. One of the two conductive layers is made of a metal having low resistivity, for example an aluminum-based metal, a silver-based metal, or a copper-based metal, in order to reduce signal delay or voltage drop. The other conductive layers are made of a material having good contact characteristics to other materials, particularly to ITO (indium tin oxide) and IZO (indium zinc oxide), such as a molybdenum-based metal, chromium, titanium, and tantalum. For examples, a combination of a lower chromium layer and an upper aluminum (alloy) layer, and a combination of a lower aluminum (alloy) layer and an upper molybdenum (alloy) layer. However, the gate lines 121 and the storage electrode lines 131 may be made of various metals and conductive materials not explicitly listed herein.

### The side surfaces of the gate lines 121 and the storage electrode lines 131 are slanted with respect to a surface of the substrate 110 so as to form an angle in the range of 30° to 80° with respect to the substrate 110.

A gate insulating layer 140 made of a silicon nitride (SiNx), silicon oxide (SiOx), or the like is formed on the gate lines 121 and the storage electrode lines 131.

A plurality of first and second semiconductor stripes 151 made of hydrogenated amorphous silicon (“a-Si”) or polysilicon are formed above the gate insulating layer 140. Each semiconductor stripe 151 extends substantially in the longitudinal direction and has a plurality of projections 154 branched out toward the gate electrodes 124. The width of each semiconductor stripe 151 becomes large near the storage electrode lines 131 such that the semiconductor stripe 151 covers large areas of the storage electrode lines 131. A plurality of ohmic contact stripes and islands 161 and 165 are formed on the semiconductor stripes 151. The ohmic contact stripes and islands 161 and 165 may be made of silicide or n+hydrogenated a-Sᵢ heavily doped with an n-type impurity such as phosphorous. Each ohmic contact stripe 161 has a plurality of projections 163, and the projections 163 and the ohmic contact islands 165 are located in pairs on the projections 154 of the semiconductor stripes 151.

The lateral sides of the semiconductor stripes 151 and the ohmic contacts 161 and 165 are tapered, and the inclination angles thereof are in a range between about 30° to 80°.

### A plurality of data lines 171 and a plurality of drain electrodes 175 are formed on the ohmic contacts 161 and 165 and the gate insulating layer 140.

The data lines 171 for transmitting data voltages extend substantially in the longitudinal direction and intersect the gate lines 121 and the storage electrode lines 131. Each data line 171 includes a plurality of source electrodes 173 extending toward the gate electrodes 124 and an end portion 179 having a large area for contact with another layer or an external driving circuit. A data driving circuit (not shown) for generating the data signals may be mounted on an FPC film (not shown), which may be attached to the insulating substrate 110, directly mounted on the insulating substrate 110, or integrated with the insulating substrate 110. The data lines 171 may extend to be directly connected to a driving circuit that may be integrated with the insulating substrate 110.

The drain electrodes 175 are separated from the data lines 171 and disposed opposite the source electrodes 173 with respect to the gate electrodes 124. Each of the drain electrodes 175 includes an end portion having a large area and a bar-shaped end portion. The end portion having a large area overlaps the enlarged portions 137 of the storage electrode lines 131, and the bar-shaped end portion is partly enclosed by the source electrodes 173 that are curved.

One gate electrode 124, one source electrode 173, and one drain electrode 175 together with a projection 154 of a semiconductor stripe 151 constitute one thin film transistor (TFT), and a channel of the thin film transistor is formed on the projection 154 between the source electrode 173 and the drain electrode 175.

The data lines 171 and the drain electrodes 175 may be made of a molybdenum-based metal, chromium, a refractory metal such as tantalum and titanium, or an alloy thereof, and may have a multi-layered structure that includes a refractory metal layer (not shown) and a low resistance conductive layer (not shown). As an example of the multi-layered structure, there are a two-layered structure of a lower chromium or molybdenum (alloy) layer and an upper aluminum (alloy) layer, and a three-layered structure of a lower molybdenum (alloy) layer, an intermediate aluminum (alloy) layer, and an upper molybdenum (alloy) layer. However, the data lines 171 and the drain electrodes 175 may be made of various metals and conductive materials not explicitly listed herein.

The side surfaces of the data lines 171 and the drain electrodes 175 are preferably slanted to form an angle ranging from 30° to 80° with respect to the substrate surface.

The ohmic contacts 161 and 165 are interposed between the underlying semiconductors stripes 151 and the overlying data lines 171 and the overlying drain electrodes 175 thereon, and reduce contact resistance therebetween. Although the semiconductor stripes 151 are narrower than the data lines 171 at most places, the width of the semiconductor stripes 151 becomes large near the gate lines 121 as described above, to smooth the profile of the surface, thereby preventing disconnection of the data lines 171. The semiconductor stripes 151 include a plurality of exposed portions, which are not covered with the data lines 171 and the drain electrodes 175, such as portions located between the source electrodes 173 and the drain electrodes 175.

A passivation layer 180 is formed on the data lines 171, the drain electrodes 175, and the exposed portions of the semiconductor stripes 151. The passivation layer 180 is made of an inorganic insulating material or an organic insulating material, and may have a flat surface. Examples of the inorganic insulating material may include silicon nitride and silicon oxide. The organic insulating material may have photosensitivity, and preferably has a dielectric constant lower than 4.0. The passivation layer 180 may have a dual-layered structure including a lower inorganic layer and an upper organic layer so that excellent insulation properties of an organic film are exhibited and the exposed portions of the semiconductor stripes 151 are not damaged.

The passivation layer 180 is provided with a plurality of contact holes 182 and 185, through which the end portions 179 of the data lines 171 and the drain electrodes 175 are exposed, respectively. A plurality of contact holes 181 are formed in the passivation layer 180 and the gate insulating layer 140, and the end portions 129 of the gate lines 121 are exposed through the contact holes 181.

A plurality of pixel electrodes 191 and a plurality of contact assistants 81 and 82 are formed on the passivation layer 180. They are made of a transparent conductor such as IZO or ITO, or a reflective conductor such as Al, Ag, Cr, or any of their alloys.

The pixel electrodes 191 are physically and electrically connected to the drain electrodes 175 through the contact holes 185 in order to receive the data voltages from the drain electrodes 175. The pixel electrodes 191 supplied with the data voltages generate electric fields in cooperation with a common electrode (not shown) on the other panel (not shown) supplied with a common voltage, which determines the orientations of liquid crystal molecules in the liquid crystal layer (not shown) disposed therebetween. Polarization of light passing through the liquid crystal layer changes according to the determined orientations of the liquid crystal molecules. The pixel electrodes 191 and the common electrode constitute capacitors (hereinafter, “liquid crystal capacitors”) that maintain the applied voltages even after the thin film transistors turn off.

The capacitors constituted by the pixel electrodes 191 and the drain electrodes 175 electrically connected thereto overlapping the storage electrode lines 131 are referred to as storage capacitors, and the storage capacitors enhance the voltage sustaining capability of the liquid crystal capacitors. The enlarged portions 137 of the storage electrode lines 131 increase the overlapping area, thereby increasing the capacitance of the storage capacitors.

The contact assistants 81 and 82 are connected to the end portions 129 of the gate lines 121 and the end portions 179 of the data lines 171 through the contact holes 181 and 182, respectively. The contact assistants 81 and 82 supplement adhesion between the exposed end portions 129 and 179 and exterior devices, and further serve to protect the end portions 129 and 179.

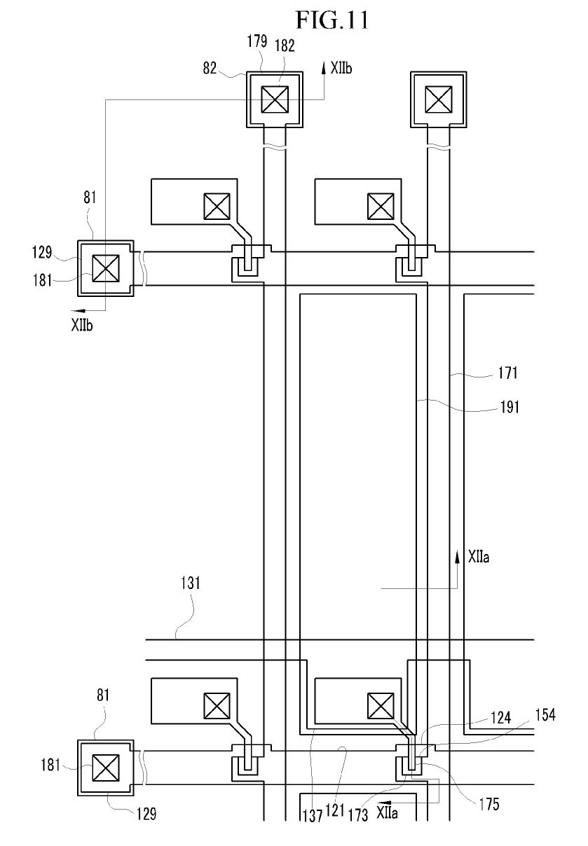

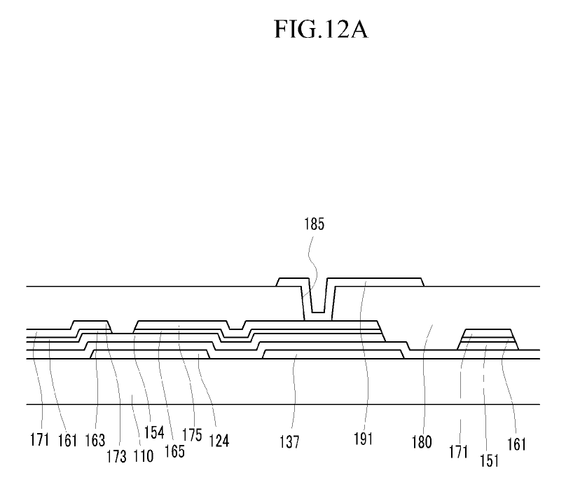

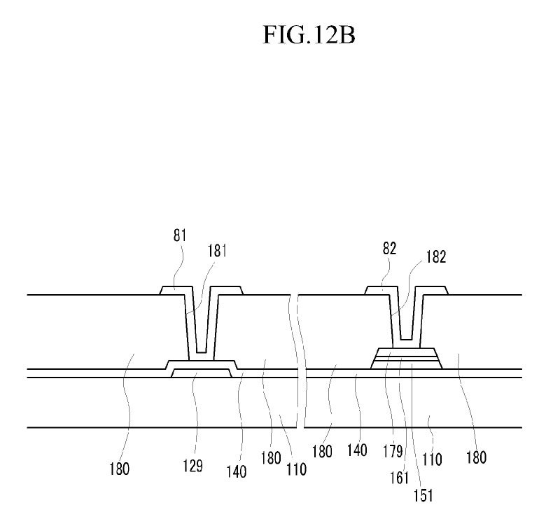

Another example of the thin film transistor array panel according to an exemplary embodiment of the present invention will be described in detail with reference to FIGS. 11 to 12B.

FIG. 11 is a layout view showing another example of a thin film transistor array panel according to one exemplary embodiment of the present invention, and FIG. 12A and FIG. 12B are cross-sectional views taken along lines XIIa-XIIa and XIIb-XIIb, respectively, of the thin film transistor array panel of FIG. 11.

The structure of the thin film transistor array panel shown in FIGS. 11 to 12B is almost the same as that as shown in FIGS. 9 to 10B.

A plurality of gate lines 121 having gate electrodes 124 and end portions 129 and a plurality of storage electrode lines 131 provided with a plurality of enlarged portions 137 are formed on a substrate 110. A gate insulating layer 140, a plurality of semiconductor stripes 151 including projections 154, and a plurality of ohmic contact stripes 161 and ohmic contact islands 165 including projections 163 are sequentially formed thereon. A plurality of data lines 171 including source electrodes 173 and end portions 179 and a plurality of drain electrodes 175 are formed on the ohmic contacts 161 and 165, and a passivation layer 180 is formed thereon. A plurality of contact holes 181, 182, and 185 are formed in the passivation layer 180 and the gate insulating layer 140. A plurality of pixel electrodes 191 and a plurality of contact assistants 81 and 82 are formed thereon.

However, in the thin film transistor array panel according to the present exemplary embodiment, the semiconductor stripes 151 have substantially the same planar shapes as the data lines 171, the drain electrodes 175, and the underlying ohmic contacts 161 and 165, except for the projections 154 where TFTs are provided. In particular, the semiconductor stripes 151 include some exposed portions, which are not covered with the data lines 171, the drain electrodes 175, and the underlying ohmic contacts 161 and 165, such as portions located between the source electrodes 173 and the drain electrodes 175.

Various characteristics of the thin film transistor array panel as shown in FIGS. 9 to 10B are applicable to the thin film transistor array panel as shown in FIGS. 11 to 12B.

According to the present invention, the power consumption of the liquid crystal display can be reduced, and the response speed of liquid crystal can be enhanced.

What is claimed is:

1. A liquid crystal display, comprising a plurality of pixels arranged in a matrix, each pixel comprising:
a liquid crystal capacitor; and
a storage capacitor having a first terminal connected to the liquid crystal capacitor and a second terminal supplied with a storage electrode voltage,
wherein the storage electrode voltage has a first level and a second level that are periodically changed and the first level is a higher voltage than the second level, and
the storage electrode voltage is dropped by a predetermined compensation value ΔV at the time of change from the first level to the second level and raised by the compensation value ΔV at the time of change from the second level to the first level.

2. The liquid crystal display of claim 1, wherein the compensation value ΔV is greater than 0V.

3. The liquid crystal display of claim 1, wherein the duration Δt of applying the compensation value is longer than 0 seconds and shorter than one horizontal period.

4. The liquid crystal display of claim 1, wherein the level of the storage electrode voltage supplied to the second terminal is changed for each of a plurality of frames.

5. The liquid crystal display of claim 4, wherein the level of the storage electrode voltage is changed after the charging of the liquid crystal capacitor.

6. The liquid crystal display of claim 1, wherein a level of the storage electrode voltage applied to an adjacent storage capacitor is different than the level of storage electrode voltage applied to the storage capacitor.

7. The liquid crystal display of claim 1, wherein the liquid crystal display is driven by row inversion.

8. The liquid crystal display of claim 1, wherein the liquid crystal display is driven by frame inversion.

9. The liquid crystal display of claim 1, wherein the compensation value varies depending on a gray level of a current frame.

10. The liquid crystal display of claim 9, wherein the compensation value is determined by comparison between an input image signal of a current frame including a current input image signal and an input image signal of a previous frame including a previous input image signal.

11. The liquid crystal display of claim 10, wherein the compensation value is determined by comparison between a mean value of the current input image signal and a mean value of the previous input image signal.

12. The liquid crystal display of claim 11, wherein the mean value of the current input image signal and the mean value of the previous input image signal are calculated in units of pixel rows.

13. The liquid crystal display of claim 11, wherein the greater the difference between the mean value of the current input image signal and the mean value of the previous input image signal is, the greater the compensation value is.

14. The liquid crystal display of claim 11, further comprising:
a plurality of gate lines transmitting gate signals;
a plurality of data lines transmitting data voltages;
storage electrode lines transmitting a storage electrode voltage;
a storage electrode driver generating the storage electrode voltage; and
a signal controller correcting an input image signal and outputting the corrected input image signal as an output image signal, and controlling the storage electrode driver.

15. The liquid crystal display of claim 14, wherein the signal controller comprises:
a first calculator calculating and outputting a mean value of the current input image signal;
a buffer unit storing the mean value of the current input image signal and outputting the same as a mean value of the previous input image signal; and
a second calculator generating a control signal for determining the compensation value by comparing the mean value of the current input image signal and the mean value of the previous input image signal.

16. The liquid crystal display of claim 15, wherein the control signal is applied to the storage electrode driver

17. The liquid crystal display of claim 15, wherein the second calculator comprises a lookup table.

18. A driving method of a liquid crystal display, the liquid crystal display including a plurality of pixels, each pixel including a liquid crystal capacitor and a storage capacitor having a first terminal connected to the liquid crystal capacitor and a second terminal applied with a storage electrode voltage, comprising:
charging the liquid crystal capacitor;
changing a voltage of the liquid crystal capacitor by changing the storage electrode voltage from a first level to a second level; and
changing the voltage of the liquid crystal capacitor by changing the storage electrode voltage from the second level to a third level.

19. The method of claim 18, wherein the first level is higher than the second level, and the second level is higher than the third level.

20. The method of claim 18, wherein the first level is lower than the second level, and the second level is lower than the third level.

21. The method of claim 18, wherein the difference between the second level and the third level is the same for each of a plurality of frames.

22. The method of claim 18, wherein the difference between the second level and the third level varies depending on a gray level of a current frame.

23. The method of claim 22, wherein the difference between the second level and the third level is determined by comparison between a mean value of an input image signal of the current frame (hereinafter, “current input image signal”) and a mean value of an input image signal of the previous frame (hereinafter, “previous input image signal”).

24. The method of claim 23, wherein the greater the difference between the mean value of the current input image signal and the mean value of the previous input image signal is, the greater the difference between the second level and the third level is.
